(19) United States
(12) Patent Application Publication
(10) Pub. No.: US 2014/0349130 A1
(43) Pub. Date: Nov. 27, 2014

(54) FLEXIBLE SCRATCH RESISTANCE FILM FOR DISPLAY DEVICES

(71) Applicant: UNIPIXEL DISPLAYS, INC., The Woodlands, TX (US)

(72) Inventors: Robert J. Petcavich, The Woodlands, TX (US); Danliang Jin, The Woodlands, TX (US)

(21) Appl. No.: 14/354,507

(22) PCT Filed: Jun. 12, 2012
(86) PCT No.: PCT/US2012/042050

§ 371 Date: Aug. 5, 2014

Related U.S. Application Data
(60) Provisional application No. 61/551,009, filed on Oct. 25, 2011.

(51) Int. Cl. G02B 1/10; C09D 135/02; C08J 7/04

(52) U.S. Cl. CPC G02B 1/105; C08J 7/04; C09D 135/02; C08J 2433/08; C08J 2369/00; C08J 2367/00
USPC 428/480; 524/854

(57) ABSTRACT

A method for the manufacture of a transparent, scratch resistant film, comprising: (1) cleaning a surface of a flexible substrate; (2) altering the surface energy of the surface of the flexible substrate; (3) coating the surface of the flexible substrate with a transparent, scratch resistant coating comprising functionalized group monomers and a solvent; (4) wetting the transparent, scratch resistant coating; and (5) forming a cross-linked polymer structure by curing the transparent, scratch resistant coating.

### CROSS-REFERENCE TO RELATED APPLICATION

The present application claims priority to U.S. Provisional Patent Application No. 61/551,009, filed on Oct. 25, 2011 titled “Methods and Application of Flexible Scratch Resistance Film for Display Devices,” and which is incorporated herein by reference.

### BACKGROUND

Touch screen technology has become an important component of many modern electronics, such as tablet computers and cellular phones. Typically, touch screen technology incorporates the use of resistive or capacitive sensor layers which make up part of the display. Screens for devices which utilize such technology are often prone to damage due to the increased level of direct contact by the user with the screen. Such damage typically includes both scratching and breakage of the screen itself depending on the materials used and the use thereof. As a result, resistive and capacitive touch sensors usually include translucent electrically insulating covers placed on top of the display structure in order to protect and isolate the touch sensor panel from environmental conditions, abrasion, oxygen, and harmful chemical agents.

Typically, glass or polyester films are employed as protective covers in touch screen panels. Polyester films, while flexible, can only provide a minimal level of hardness. Specifically, such films provide a surface harness ranging from about 2 H to 4 H. Therefore, polyester films are susceptible to scratches. Additionally, glass covers, which are able to produce pencil hardness readings above 7 H, do provide very good scratch protection. However, such glass covers do not provide a high level of flexibility and are therefore susceptible to breaking upon impact with a hard surface.

### SUMMARY

The present disclosure relates to methods of forming an transparent, scratch resistant coating on a flexible and transparent substrate film that can achieve a pencil surface hardness greater than 6 H. Specifically, some embodiments are directed to a flexible, scratch resistant film, comprising a flexible substrate and a transparent, scratch resistant coating adhered to the flexible substrate, wherein the transparent, scratch resistant coating comprises a cross-linked polymer structure formed from functionalized monomers.

Other embodiments are directed to a method for the manufacture of a transparent, scratch resistant film, comprising: (1) cleaning a surface of a flexible substrate; (2) altering the surface energy of the surface of the flexible substrate; (3) coating the surface of the flexible substrate with a transparent, scratch resistant resin coating comprising functionalized group monomers and a solvent; (4) depositing the transparent, scratch resistant coating; and (5) forming a cross-linked polymer structure by curing the transparent, scratch resistant coating.

Still other embodiments are directed to A flexible, scratch resistant film, comprising a flexible substrate, a transparent, scratch resistant coating adhered to the flexible substrate, wherein the transparent, scratch resistant coating comprises a cross-linked polymer structure formed from functionalized monomers, a pencil hardness of the flexible, scratch resistant film is at least 6 H, and the transparent, scratch resistant coating has a cross-link density of at least 50%.

### BRIEF DESCRIPTION OF THE DRAWINGS

For a detailed description of exemplary embodiments of the invention, reference will now be made to the accompanying drawings in which:

FIG. 1 shows both a linear polymer structure (A) as well as a cross-linked polymer structure (B) in accordance with an embodiment of the invention;

FIG. 2 shows a schematic view of an embodiment of the method for making the transparent, scratch resistant film;

FIG. 3 shows a schematic view of an alternative embodiment of the method for making the transparent, scratch resistant film;

FIG. 4 shows a schematic view of still another alternative embodiment of the method for making the transparent, scratch resistant film;

FIG. 5 depicts a schematic view of a cross-section of the transparent, scratch resistant film in accordance with an embodiment of the invention; and

FIG. 6 shows the apparatus for conducting a pencil hardness test on the surface of the transparent, scratch resistant film.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

As used herein, the word “approximately” means “plus or minus 10%.” Additionally, as used herein, the word “transparent” means any material that's allows the transmission of light waves within a transmittance rate of 90% or greater.

Most coating films applied in touch screen devices exhibit a polymer-based molecular structure. Polymers are relatively large molecules which result from chemically linking thousands of relatively small molecules called monomers. Monomers, due to their weak intermolecular forces, can exist in the form of gases, liquids, or structurally weak molecular structures.

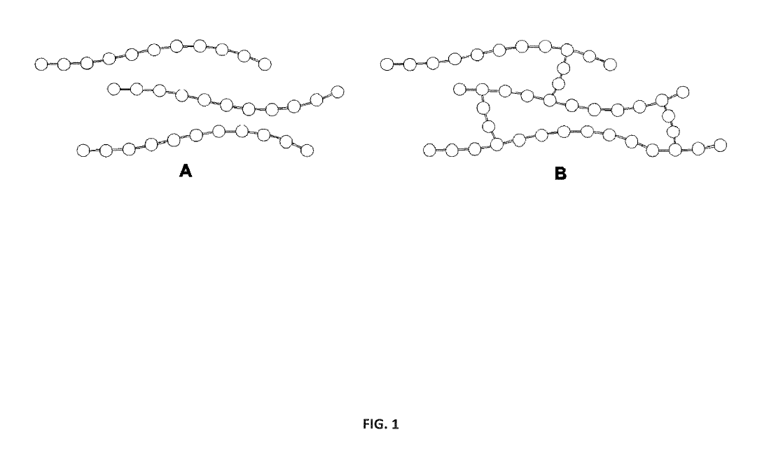

FIG. 1 shows an example of a linear polymer structure A and a cross-linked polymer structure B. As used herein, the term “Cross-Linked” refers to chemical bonds (covalent or ionic) that link one monomer or polymer chain to another. In a typical polymerization reaction, monomers with dual functional groups are joined together to form polymers in a linear polymer structure A. However, films made with a polymer-based coating film containing linear polymer structure A, are not usually scratch resistant. Therefore, in order to increase the scratch resistance of the coating film, the mechanical strength of the polymeric coating needs to be enhanced.

Cross-linked polymer structures B are linked together in a three dimensional structure that increases the intermolecular forces (usually covalent bonds) within the polymer chains and reduces the polymeric chain relaxation that usually manifests as a dent or gouge under pressure. Therefore, polymer-based coating films which contain cross-linked polymer structures B, will tend to have scratch resistant properties.

Although the molecular strength is higher for a cross-linked polymer structure, application or coating of the polymer onto a substrate may not be possible through a solution process. This is due to the fact that cross-linked polymers cannot dissolve in a solvent and typically swell when placed therein. Coating compositions in a liquid state allow molecules to move and react more efficiently. Materials with low density cross-linked networks behave as viscous, liquid-like gels, while materials with high density cross-linked networks are very rigid in their solid state. In accordance with the preferred embodiments, a cross-linked structure is created after it is applied to a substrate in a liquid form. The cross-linked structure may be formed after the polymer is applied to the substrate.

Embodiments of the invention employ a transparent, scratch resistance coating based on a cross-linked structure that does not originate from a polymer chain. Instead, the coating may be comprised of monomers that react simultaneously at different joint points to create a cross-linked, three dimensional polymer structure that exhibits very high cross-linked densities, and hence, scratch resistant features. Specifically, the transparent, scratch resistant coating may comprise mono and multifunctional acrylic monomers and oligomers. This coating may be applied over a transparent and flexible film that can be used as a protective cover for displays in electronic devices such as cellular phones and tablet computers.

FIG. 2 shows a coating application system 200 for producing a transparent, scratch resistant film 500 in accordance with the various embodiments of the current invention. Coating application system 200 generally includes a corona treatment module 206, a coating module 208, a transition zone 202, and a curing module 216. During operation, a flexible and transparent substrate 204 is fed into the coating application system 200 from an unwind roll 212. Substrate 204 is then advanced through corona treatment module 206, coating module 208, transition zone 204, and curing module 216, respectively resulting in transparent, scratch resistant film 500. Upon exiting curing module 216, transparent, scratch resistant film 500 is deposited on a wind-up roll 218. Each of the above mentioned modules and steps will now be described in more detail below.

Corona treatment module 206 removes any small particles, oils, and grease from the surface of the substrate 204 as it is desirable, in at least some embodiments, to have a clean surface before the application of the scratch resistant coating 202. Additionally, corona treatment module 206 may also be used to alter (e.g., increase) the surface energy to obtain sufficient wetting and adhesion on the substrate 204. As substrate 204 passes through corona treatment module 206, high frequency electrons are discharged onto the surface of substrate 204, forming high polarity groups, which can react with coating compositions and form hydrogen bonds which results in improved adhesion. Generally speaking, when higher levels of electrons are discharged onto the surface of substrate 204, more polar groups and adhesion points are formed which ultimately results in higher surface energy.

In some embodiments, substrate 204 may comprise polyethylene terephthalate (PET), polyethylene naphthalate (PEN), polycarbonate, cellulosic polymer or glass. Specifically, suitable materials for substrate 204 may include DuPont/Teijin Melinex 454 and Dupont/Teijin Melinex ST505, the latter being a heat stabilized film specially designed for processes where heat treatment is involved. Additionally, the thickness of substrate 204 may range from 12 to 500 microns, with a preferred thickness of 50 to 150 microns.

Depending on the material used for substrate 204, the required corona treatment may vary by watt/density within a wide range. For example, when substrate 204 is composed of PET film, the intensity level in Corona treatment module 206 may range from about 1 to 50 W/min/m², while the preferred surface energy may range from about 40 to 95 Dynes/cm. Alternatively, when substrate 204 is composed of polycarbonate, the intensity level in Corona treatment module 206 may range from about 1 to 50 W/min/m², while preferred surface energy may range from about 40 to 95 Dynes/cm.

Upon exiting corona treatment module 206, substrate 204 enters coating module 208. Coating module 208 is used to apply a uniform layer of transparent, scratch resistant coating 202 on substrate 204. In the embodiment shown, coating module 208 utilizes a Slot-Die process in which coating module 208 squeezes out transparent, scratch resistant coating 202 by pressure or gravity onto flexible and transparent substrate 204, forming a relatively precise, conformal layer with a thickness ranging from about 3 to 50 microns, with the preferred thickness being between 15 and 20 microns. Instead of a Slot Die coating process, transparent, scratch resistant coating 202 may also be applied through other commonly employed coating techniques such as Gravure Coating, Meier Rod Coating, and spray coating.

Transparent, scratch resistant coating 202 may be composed of solid content within a concentration by weight of up to 100%, with a photo-initiator or thermo-initiator concentration in the range of about 1% to 6%. Additionally, coating 202 may contain about 20% to 30% solvent to regulate viscosity, which will depend on the coating method used and the desired thickness. Examples of potential solvents may include ketone type solvents such as acetone, methyl ethyl ketone, and iso-butyl ethyl ketone, as well as alcohol type solvents such as ethoxy ethanol and methoxy ethanol. The addition of a solvent does not affect coating 202's properties because it evaporates after application when it goes through an oven channel. Such solvents may also eliminate any residuals left after substrate 204 passes through corona treatment module 206.

In other embodiments, coating 202 may be composed of 100% of solid content. Generally, when 100% solids content are used, the preferred coating thickness of coating 202 remains substantially the same after being deposited on substrate 204 in coating module 208 and passing through curing module 216 (described below). It is easier o achieve thicker coating while using 100% solid resins. Alternatively, when a solvent is used, the thickness of coating 202 will reduce as it is moved throughout coating application system 200 due to the fact that the solvent evaporates out. For example, if a transparent, scratch resistant coating 202, with a thickness of 20 microns and having a solvent concentration of 20%, is deposited on substrate 204, the thickness may be reduced by 20% or down to 16 microns or less after passing through curing module 216. The solvents can help manipulate the viscosity that can match the coating facility operation required and it is relatively easier to achieve a thinner coating.

As stated above, transparent, scratch resistant coating 202 is comprised of functional group monomers which react to form a cross-linked polymer structure. Examples of potential functional group monomers that can be used may include propoxylated trimethylolpropane tri(meth)acrylate, highly propoxylated glyceryl triacrylate, trimethylolpropane triacrylate, high purity trimethylolpropane triacrylate, low viscosity trimethylolpropane triacrylate, pentaerythritol triacrylate, propoxylated trimethylolpropane triacrylate, trifunctional acrylate ester, pentaerythritol tetraacrylate, di-trimethylolpropane tetraacrylate, dipentaerythritol pentaacrylate, ethoxylated pentaerythritol tetraacrylate, and pentaacrylate ester.

Additionally, in order to have proper viscosity for coating process and to control the stress of the cross-linked polymer, lower functionalized monomers can also be introduced. Examples of potential lower functionalized monomers which may be used include polyethylene glycol diacrylate, dipropylene glycol diacrylate, propoxylated neopentyl glycol diacrylate, 1,3-butylene glycol dimethacrylate, neopentyl glycol dimethacrylate, 1,6 hexanediol dimethacrylate, 1,4-butanediol dimethacrylate, and diethylene glycol dimethacrylate.

Finally, a photo initiator can be included in transparent, scratch resistant coating 202 when such coating is cured using a UV light source (discussed below). Examples of potential photo initiators include Benzophenone type initiators such as benzophenone, 4,4′-Dihydroxybenzophenone, 3-hydroxybenzophenone, 4-hydroxybenzophenone, 2-methyl-4′-(methylthio)-2-morpholinopropiophenone, and acetophenone.

Referring still to FIG. 2, once substrate 204 is coated with transparent, scratch resistant coating 202, the combination of substrate 204 and coating 202 moves on to transition zone 214. Transition zone 214 allows for the proper wetting of coating 202 across the surface of substrate 204. Furthermore, transition zone 214 may be held at room temperature (between 20° C. and 30° C.) or at an elevated temperature and may allow for a process time of about 5 to 300 seconds for a given segment of material. At room temperature, the transition zone 214 allows the coating to settle down and even out over a large area substrate. At an elevated temperature, the viscosity of the coating is reduced and a smooth and flat surface can be achieved with relative ease. When solvent is present, the elevated temperature can help to evaporate solvents before the curing process.

Upon exiting transition zone 214, substrate 204 and coating 202 passes into curing module 216. While in curing module 216, coating 202 forms a cross-linked polymer structure (see B in FIG. 1), which gives coating 202 its scratch resistant properties. The reaction of the multiple functionalized monomers into a cross-linked polymer structure preferably occurs while coating 202 is still in a liquid state to allow the monomers to move around and, as a result, achieve a more efficient cross-linking structure. Additionally, in order to achieve a high cross-link density, it is also preferable to cure coating 202 in an inert gas environment or in an environment substantially free of oxygen (e.g. less than 1% oxygen). An example of a suitable inert gas for this process is nitrogen and carbon dioxide.

In the embodiment shown, curing module 216 utilizes a ultra-violet (UV) light source 215 which cures coating 202 as it passes through the curing module 216. UV light source 216 can be a UVA, UVB, or UVC ultraviolet light source, and preferably is an industrial grade UV light source since it is desired to cure coating 202 in a very short period of time. Specifically, it is desired to cure coating 202 in the order of about 0.1 to 2.0 seconds. Additionally, it is desirable for the UV light source 215 to have a wavelength from about 280 to 480 nm, with target intensity in the range of about 0.25 to 20.00 J/cm², under ambient atmosphere. Finally, if an inert environment is applied, the UV light intensity requirement can be reduced up to one order of magnitude and to achieve an equivalent degree of crosslinking

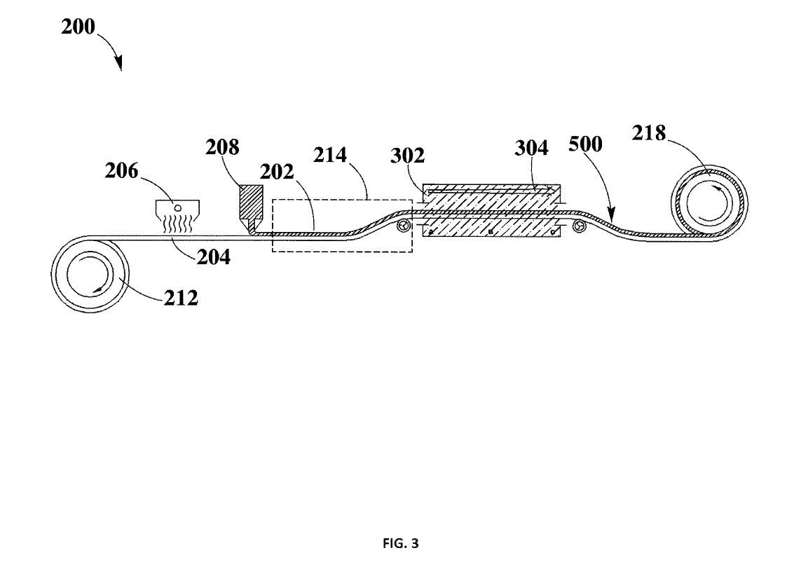

Referring now to FIG. 3, an alternative embodiment of the current invention is shown. Here, transparent, scratch resistant film 500 is produced in substantially the same manner as is described in FIG. 2 above. However, in lieu of a UV light source (Numeral 215 in FIG. 2), thermo-curing module 302 utilizes heat radiation along a temperature gradient 304 to cause coating 202 to form a cross-linked polymer structure. Temperature gradient 304, in curing module 302 is designed such that it progressively cures coating 202 within a period of time of about 5 to 300 seconds, reducing the thermal stress and avoiding any possible curl-up effect on coating 202. Specifically, temperature gradient 304 creates and maintains three temperature zones A, B, and C, which may range from 70° C., 120° C., and 200° C. respectively. If a thermo-initiator is included in coating 202, while passing through thermo-curing module 302, the activation temperature of such thermo-initiator may range from 70° C. to 200° C. The preferred temperature is in the range of 70-150 ° C., which should match the stability of the substrate.

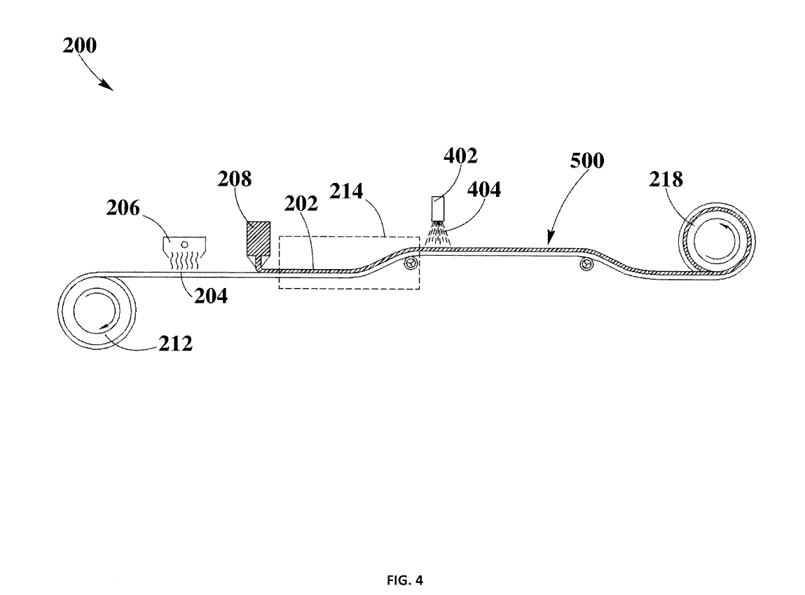

Referring now to FIG. 4, an alternative embodiment of the current invention is shown. Here, transparent, scratch resistant film 500 is produced in substantially the same manner as is described in FIG. 2 above. However, in lieu of a UV light source (Numeral 215 in FIG. 2), the current embodiment utilizes ionizing radiation to cure and form a cross-linked polymer structure within coating 202. Specifically, the embodiment shown employs an Electronic-beam (E-Beam) module 402 to perform this step. According to the current embodiment, E-beam curing module 402 applies an electron discharge 404 to cure the scratch resistant coating. More specifically, E-beam module 402 utilizes highly energetic electrons at controlled doses to quickly polymerize and cross-link polymeric materials. There is no need to use either a thermo or photo initiator within transparent, scratch resistant coating 202 when employing an E-Beam module 402, because the electrons within the solution act as the initiator. E-beam doses applied on the scratch resistant coating 202 may range from about 0.5 to 5 MRads for about 0.01 to 5 seconds.

Cross-link density refers to the percentage of cross-linked bonds within a given polymer. Such density is related to reaction time and temperature. Generally, a higher intensity and faster reaction translates into a higher cross-linked density. As such, different curing methods provide different densities in terms of the percentage of cross-linked reaction. Maximum cross-linked densities may range from about 50% to 60% using a thermo curing process, 60% to 70% using UV curing, and up to 80% using E-beam curing. From a manufacturing perspective, in terms of processing speed, cost and power requirements, UV curing may be the preferred curing method. Alternatively, if a superior optical finish is desired, thermo-curing may be preferred.

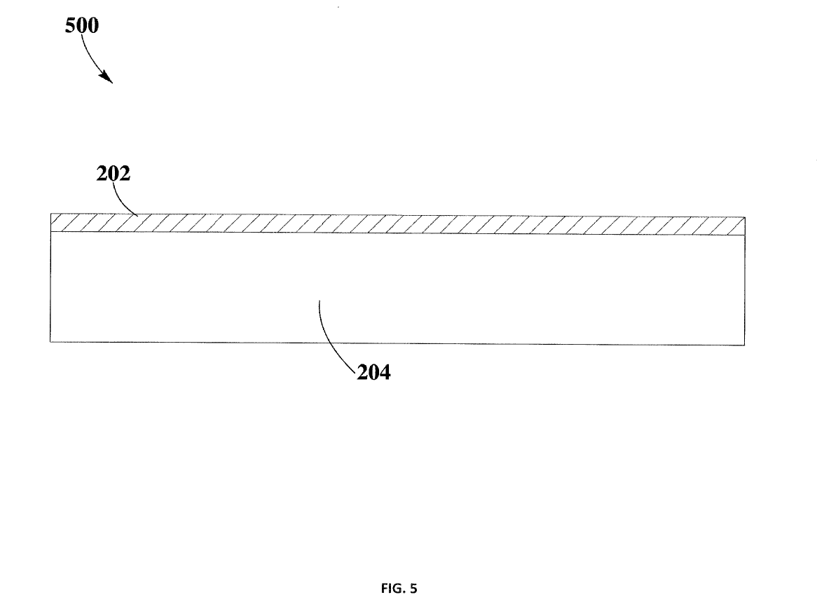

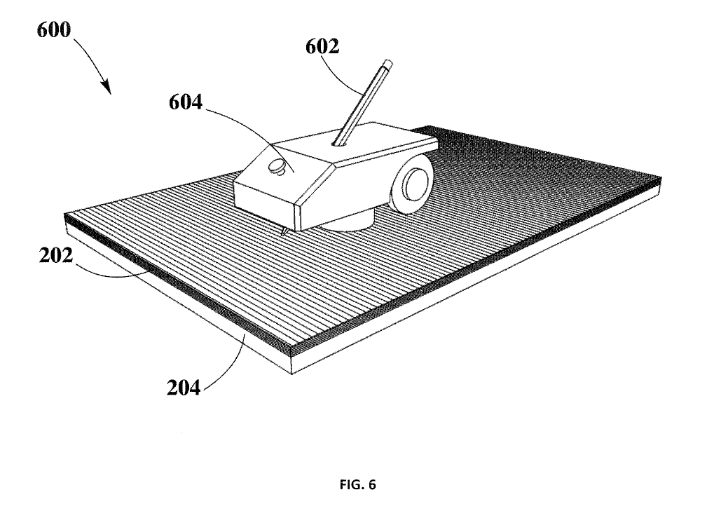

Referring to FIG. 5, a cross-section of transparent, scratch resistant film 500 is shown. Transparent, scratch resistant film 500 generally includes a flexible and transparent substrate 204, and a transparent, scratch resistant coating 202. Furthermore, coating 202 may add about 10 to 20% of weight compared to the total weight of transparent, scratch resistant film 500 depending on the size the of the electronic display that requires protective cover.

In some embodiments, transparent, scratch resistant film 500 may further include a transparent and flexible adhesive layer (not shown), which is adhered to substrate 204 opposite coating 202. Adhesive layer allows attachment of transparent, scratch resistant film 500 to electronic touch displays which include those found on devices such as, mobile phones and tablet computers. The thickness of the adhesive layer may range from about 20 to 50 microns. For example, adhesive layer may be constructed from 3M Optically Clear Adhesive #8171.

Referring now to FIG. 6, a pencil hardness test 600, which complies with test method ASTM D3363, for measuring the surface hardness of coating 202, is shown. To perform the test, a pencil 602 is selected from set of pencils that exhibit hardness ranging from 6 B to 9 H. Selecting from highest to lowest hardness, a first pencil 602 is loaded into the measuring cart 604. The measuring cart 604 used in this test is the Elcometer 3080 which is commercially available from BAMR. This measuring instrument enables pencil 602 to be maintained at a constant pressure force of about 7.5 N, and at the appropriate angle, which increases the reproducibility of the test. With pencil 602 loaded, measuring cart 604 is moved across the surface of coating 202. If the pencil 602 leaves a scratch, the next softer pencil 602 is used and the process is repeated. The hardness number of the first pencil 602 that does not leave a mark is considered the pencil hardness of coating 202.

Using thicknesses from about 5 to 50 microns, pencil hardness of coating 202 on top of the substrate 204 that is made of PET is measured from 2 H up to 9 H, depending on the thickness of the scratch resistant coating 202. Employing a preferred thickness of 15 microns on the scratch resistant coating 202 over PET substrate 204, surface pencil hardness greater than or equal to 6 H can be achieved. Performance characteristics of coating 202 that is applied to a PET substrate 204 are shown in Table 1.

TABLE 1

| CATEGORY | SPECIFICATION | CHARACTERISTICS |
|---|---|---|
| Optical | Transmittance | >93% |
| Performance | Haze | <1% |
| | Gloss | 20° = 95, 60° = 97, 85° = 99 |
| | Brightness Loss | <1.7% optical loss when on display |
| | Index of | 1.48-1.54 |
| | Refraction | |
| Scratch | Hardness | 2H-9H |
| Resistance | | |
| Thermal | Operating | −20° C. to 65° C., 90 Cycles |
| | Temperature | |
| Stress | Storage | −40° C. for 72 hrs, 85° C. for 10 hrs |
| | Temperature | |
| Chemical | Chemical | Exposure* for 1 hour @ 70° F. |
| | Resistance | |

*IPA, acetone, glass cleaner, vinegar, coffee, tea, cola, ketchup, mustard

Additionally, performance characteristics of scratch resistant coating 202 applied to a polycarbonate substrate are shown in Table 2.

TABLE 2

| CATEGORY | SPECIFICATION | CHARACTERISTICS |
|---|---|---|
| Optical | Transmittance | >93% |
| Performance | Haze | <1% |
| | Gloss | 20° = 95, 60° = 97, 85° = 99 |
| | Brightness Loss | <1.7% optical loss when on display |
| | Index of | 1.48-1.54 |
| | Refraction | |
| Scratch | Hardness | 2H-5H |
| Resistance | | |
| Thermal | Operating | −20° C. to 65° C., 90 Cycles |
| | Temperature | |
| Stress | Storage | −40° C. for 72 hrs, 85° C. for 10 hrs |
| | Temperature | |
| Chemical | Chemical | Exposure* for 1 hour @ 70° F. |
| Resistance | | |

*IPA, acetone, glass cleaner, vinegar, coffee, tea, cola, ketchup, mustard

In comparing the results of Table 1 and Table 2, it can be seen that the scratch resistance varies as a result of the different substrate materials, whereas other properties remain the same. The reason is that polycarbonate substrate is softer than PET substrate. Therefore, the maximum surface hardness that coating 202 is able to achieve is lower when applied over a polycarbonate substrate as opposed to a PET substrate.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A flexible, scratch resistant film, comprising:
a flexible substrate; and
a transparent, scratch resistant coating adhered to the flexible substrate;
wherein the transparent, scratch resistant coating comprises a cross-linked polymer structure formed from functionalized monomers.

2. The film of claim 1 wherein a pencil hardness of the film is at least 6 H.

3. The film of claim 1 wherein the transparent, scratch resistant coating has a cross-link density of at least 50%.

4. The film of claim 1 wherein the transparent, scratch resistant coating comprises mono and multi-functional acrylic monomers and acrylic oligomers.

5. The film of claim 1 wherein the flexible substrate comprises at least one of polyethylene terephthalate, polyethylene naphthalate, polycarbonate, cellulosic polymer, and glass.

6. A method for the manufacture of a transparent, scratch resistant film, comprising:
cleaning a surface of a flexible substrate;
altering the surface energy of the surface of the flexible substrate;
coating the surface of the flexible substrate with a transparent, scratch resistant coating comprising functionalized group monomers and a solvent;
wetting the transparent, scratch resistant coating; and
forming a cross-linked polymer structure by curing the transparent, scratch resistant coating.

7. The method of claim 6 wherein cleaning the surface of the flexible substrate and altering the surface energy of the surface of the flexible substrate comprises applying a stream of high frequency electrons to the surface of the flexible substrate.

8. The method of claim 7 wherein the intensity level of the stream of high frequency electrons ranges from 1 to 50 W/min/m².

9. The method of claim 6 wherein the altered surface energy of the flexible substrate ranges from 20 to 95 Dynes/cm.

10. The method of claim 6 wherein the transparent, scratch resistant coating has a thickness ranging from 3 to 30 microns.

11. The method of claim 6 wherein coating the surface of the flexible substrate with the transparent, scratch resistant coating comprises using at least one of a slot-die, Gravure, Meier Rod, and spray coating technique.

12. The method of claim 6 wherein curing the transparent scratch resistant coating comprises applying a UV light having a wavelength from 280 to 480 nm.

13. The method of claim 6 wherein curing the transparent, scratch resistant coating comprises applying heat radiation to the transparent, scratch resistant coating.

14. The method of claim 13 wherein the transparent, scratch resistant coating is subjected to three temperature zones that range from 70° C., 120° C., and 200° C. respectively.

15. The method of claim 6 wherein curing the transparent, scratch resistant coating comprises applying ionizing radiation to the transparent, scratch resistant coating.

16. The method of claim 15 wherein applying ionizing radiation further comprises using an electronic beam to the transparent, scratch resistant coating.

17. The method of claim 16 wherein applying the electron beam comprises applying doses of electrons ranging from 0.5 to 5 MRads over a time period ranging from 0.01 to 5 seconds.

18. The method of claim 6 wherein the transparent, scratch resistant coating further comprises either a photo-initiator or a thermo-initiator.

19. The method of claim 6 wherein curing the transparent, scratch resistant coating is conducted in an environment of inert gas.

20. The method of claim 6 wherein curing the protective coating solution is conducted in an environment nearly free of oxygen.

21. A flexible, scratch resistant film made according to the method of claim 6.

22. The flexible, scratch resistant film of claim 21 wherein the transparent, scratch resistant coating has a cross link density of at least 50%.

23. A flexible, scratch resistant film, comprising:
a flexible substrate;
a transparent, scratch resistant coating adhered to the flexible substrate;
wherein the transparent, scratch resistant coating comprises a cross-linked polymer structure formed from functionalized monomers;
wherein a pencil hardness of the flexible, scratch resistant film is at least 6 H; and
wherein the transparent, scratch resistant coating has a cross-link density of at least 50%.
